(19) United States
(12) Patent Application Publication
(10) Pub. No.: US 2022/0235725 A1
(43) Pub. Date: Jul. 28, 2022

(54) CYLINDER HEAD WITH INTEGRATED CATALYST

(71) Applicants: Jeff Brand, Highland, MI (US); Ryan M. Sturgeon, Rochester Hills, MI (US); Brett Schubring, Macomb, MI (US); Jeffrey P. Wuttke, Sterling Heights, MI (US)

(72) Inventors: Jeff Brand, Highland, MI (US); Ryan M. Sturgeon, Rochester Hills, MI (US); Brett Schubring, Macomb, MI (US); Jeffrey P. Wuttke, Sterling Heights, MI (US)

(21) Appl. No.: 17/158,258

(22) Filed: Jan. 26, 2021

(51) Int. Cl. F02F 1/42; F02F 1/40; F01N 3/20; F02F 1/24; F01N 3/28

(52) U.S. Cl. CPC F02F 1/4264; F02F 1/40; F01N 2260/024; F02F 1/243; F01N 3/2882; F01N 3/2046

(57) ABSTRACT

A cylinder head assembly for an internal combustion engine is provided. In one example implementation, the cylinder head assembly includes a cylinder head, a bypass passage formed within the cylinder head and defining a catalyst cavity, and a bypass catalytic converter disposed within the catalyst cavity, where the bypass catalytic converter is configured to provide emissions reduction during cold start, long idle, and/or low main catalytic converter temperature conditions.

### FIELD

The present application relates generally to internal combustion engine aftertreatment systems and, more particularly, to an internal combustion engine having a cylinder head with an integrated catalyst.

### BACKGROUND

In conventional internal combustion aftertreatment systems it is difficult to achieve low tailpipe emissions in the time immediately following a cold engine start due to low catalyst conversion efficiency of cold catalysts. In order to achieve acceptable conversion efficiency, the catalyst must surpass a predetermined light-off temperature. In some systems, faster light-off temperatures may be achieved, but often at the cost of high exhaust system backpressure, durability, longevity, cost, and/or complexity. While such conventional systems work well for their intended purpose, it is desirable to provide continuous improvement in the relevant art.

### SUMMARY

In accordance with one example aspect of the invention, a cylinder head assembly for an internal combustion engine is provided. In one example implementation, the cylinder head assembly includes a cylinder head, a bypass passage formed within the cylinder head and defining a catalyst cavity, and a bypass catalytic converter disposed within the catalyst cavity.

In addition to the foregoing, the described cylinder head assembly may include one or more of the following features: wherein the bypass passage is integrally cast within the cylinder head; an integrated exhaust manifold formed in the cylinder head and including a main exhaust passage and an outlet, the integrated exhaust manifold configured to receive exhaust gas from exhaust ports of the internal combustion engine; wherein the bypass passage includes an inlet and an outlet, the bypass passage inlet fluidly coupled to the main exhaust passage; and a valve disposed within the bypass passage and configured to selectively allow exhaust gas flow through the bypass passage and thus the bypass catalytic converter.

In addition to the foregoing, the described cylinder head assembly may include one or more of the following features: a valve disposed within the main exhaust passage and configured to selectively allow exhaust gas flow through the main exhaust passage outlet to a main catalytic converter; a second valve disposed within the bypass passage and configured to selectively allow exhaust gas flow through the bypass passage and thus the bypass catalytic converter; a water jacket formed in the cylinder head proximate the catalyst cavity and configured to circulate a coolant to provide cooling to the bypass catalytic converter; and a service port formed in the cylinder head and configured to removably receive a cap, wherein the cap is removable to enable insertion or removal of the bypass catalytic converter through the service port.

In accordance with another example aspect of the invention, an internal combustion engine system is provided. In one example implementation, the system includes a cylinder head, an integrated exhaust manifold formed in the cylinder head and including a main exhaust passage having an outlet, and a bypass passage formed within the cylinder head and defining a catalyst cavity. An exhaust aftertreatment system includes a main exhaust conduit with a main catalytic converter, wherein the main exhaust conduit is fluidly coupled to both the main exhaust passage outlet and the bypass passage. A bypass catalytic converter is disposed within the catalyst cavity and configured to provide emissions reduction during cold start, long idle, and/or low main catalyst temperature conditions.

In addition to the foregoing, the described system may include one or more of the following features: a water jacket formed in the cylinder head proximate the catalyst cavity and configured to circulate a coolant to provide cooling to the bypass catalytic converter; wherein the bypass passage is fluidly coupled to the main exhaust conduit at a location upstream of the main catalytic converter; and a valve disposed within the bypass passage and configured to selectively allow exhaust gas flow through the bypass passage and thus the bypass catalytic converter.

In addition to the foregoing, the described system may include one or more of the following features: a valve disposed within the main exhaust passage and configured to selectively allow exhaust gas flow through the main exhaust passage outlet to a main catalytic converter; a second valve disposed within the bypass passage and configured to selectively allow exhaust gas flow through the bypass passage and thus the bypass catalytic converter; and a service port formed in the cylinder head and configured to removably receive a cap, wherein the cap is removable to enable insertion or removal of the bypass catalytic converter through the service port.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a sectional view of an example cylinder head casting with an integrated auxiliary catalyst, in accordance with the principles of the present application; and

FIG. 2 is a sectional view of another example cylinder head casting with an integrated auxiliary catalyst, in accordance with the principles of the present application.

### DESCRIPTION

Described herein are systems and methods for an emissions aftertreatment system of an internal combustion engine. An auxiliary catalyst is integrated into a bypass passage in the cylinder head and utilizes the cylinder head water jacket for liquid cooling thereof. During a cold start, long idle, and/or low main catalyst temperatures, exhaust gas is selectively bypassed into the auxiliary catalyst. The close proximity of the auxiliary catalyst to the exhaust gas in the cylinder head enables rapid heating to hasten the conversion rate of harmful exhaust constituents. Additionally, due to the liquid cooling, degradation of system catalytic conversion devices is reduced compared to conventional systems.

Some conventional aftertreatment systems have limited or no capacity to get the catalyst to a light-off temperature for efficient conversion of harmful exhaust constituents before approximately fifteen seconds post cold start in a turbocharged system. Every second the engine is running and the catalyst is not at or above light-off temperature, CO HC, and NOx are not being converted efficiently. The short time preceding the catalyst light-off is responsible for a very large portion of the CO, HC, and NOx breakthrough for on and off cycle starts and long idles. In conventional systems, one or more catalysts are traditionally located some distance downstream of the exhaust outlet of the heat and/or turbocharger outlet and are typically in the main exhaust flow for the entire useful life of the vehicle.

As the distance, wetted surface area, and thermal mass located between the exhaust ports and catalyst face increases, it becomes increasingly difficult to have the catalyst light-off in a timely manner. Common hardware designs to decrease time to light-off (e.g., decreasing distance), however, often come at the expense of the life of the catalyst because of higher temperature, gas velocities, and thermal gradients. Common calibration methods used to decrease light-off time include high RPM flare/start, very late ignition timing, and special injection strategies. However, such methods can potentially generate high temperature and high flow exhaust gases, which are good for light-off but can potentially cause undesirable NVH and aging characteristics along with increased fuel consumption.

Further, as a catalyst is subjected to exhaust flow, high temperatures, and/or unwanted chemicals, it slowly loses capacity for efficient conversion (catalyst aging). Conventional systems typically account for this catalyst aging by increasing precious metal loading, catalyst volume, and catalyst surface area, which can potentially be a resource burden increase complexity of the systems.

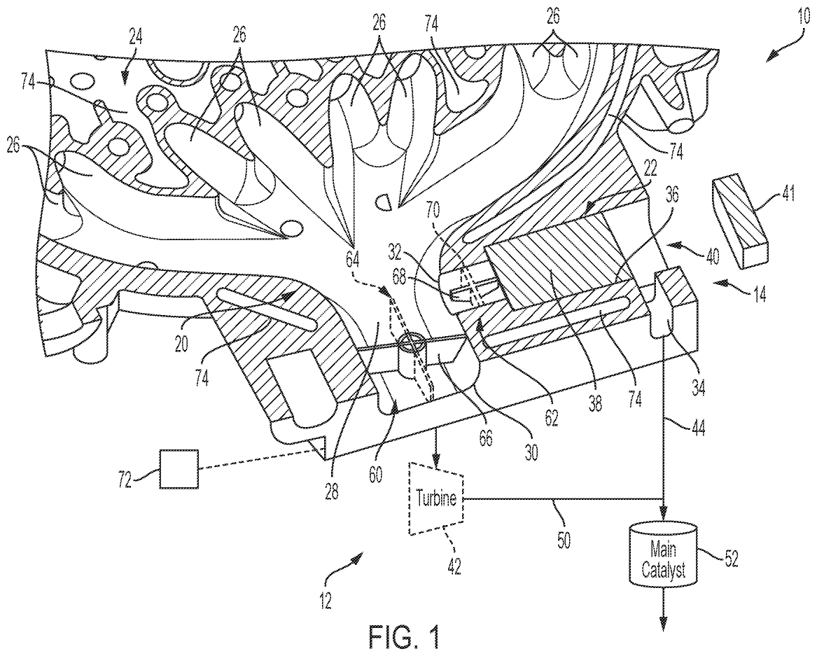

With reference to FIG. 1, an example cylinder head for an internal combustion engine is shown and indicated at reference numeral 10. In the example embodiment, the cylinder head 10 is configured to selectively supply exhaust gas to a main exhaust aftertreatment system 12 and a light-off catalyst bypass system 14. As described herein in more detail, the light-off catalyst bypass system 14 is selectively utilized during cold start, long idle, and/or cold catalyst conditions to rapidly heat to light-off temperatures to quickly achieve low tailpipe emissions.

As shown in FIG. 1, the cylinder head 10 generally defines an integrated exhaust manifold 20, a bypass passage 22, and a water jacket 24. The integrated exhaust manifold 20 includes a plurality of cylinder exhaust passages 26 that merge together to form a main exhaust passage 28 having an outlet 30. The bypass passage 22 includes an inlet 32, an outlet 34, and defines a catalyst cavity 36, which is configured to removably receive a bypass catalytic converter or catalyst 38, as described herein in more detail. Further, in the illustrated example, the catalyst cavity 36 includes a service port 40 configured to receive a removable cap or plug (not shown) to enable insertion/removal of the bypass catalyst 38, for example, for replacement thereof.

In the example embodiment, the main exhaust aftertreatment system 12 generally includes a main exhaust conduit 50 having one or more main catalytic converters 52 to reduce or convert a desired exhaust gas constituent such as, for example, carbon monoxide (CO), hydrocarbon (HC), and/or nitrogen oxides (NOx). The main exhaust conduit 50 is fluidly coupled to the integrated exhaust manifold main outlet 30 (optionally via a turbocharger turbine 42, shown in phantom) and configured to receive exhaust gas from the vehicle engine and supply the exhaust gas to the main catalytic converter 52. In order to efficiently reduce or convert CO, HC, and NOx, the catalytic converter 52 must reach a predetermined light-off temperature. However, during some vehicle operations such as, for example, cold starts, long idle, and cold catalyst conditions, the catalytic converter 52 is below light-off temperature and therefore has a low catalyst conversion efficiency.

In order efficiently reduce or convert the unwanted exhaust gas constituents while the catalytic converter 52 is below the light-off temperature, the vehicle utilizes the light-off catalyst bypass system 14 to redirect at least a portion of the exhaust gas from the integrated exhaust manifold 20, into the bypass passage 22, and through the bypass catalyst 38. Because the bypass catalyst 38 is integrated into the cylinder head 10, it is in close proximity to the engine combustion chambers and receives the exhaust gas quicker and at a higher temperature than the main catalytic converter 52 would. Thus, the bypass catalyst 38 is rapidly heated to its predetermined light-off temperature to achieve high catalyst conversion efficiency before the main catalytic converter 52 alone.

In the example embodiment, the light-off catalyst bypass system 14 generally includes the bypass catalyst 38, a first valve 60, and a second valve 62. The bypass catalyst 38 is disposed within the bypass passage 22, which is fluidly connected to the main exhaust conduit 50 upstream of the main catalytic converter 52 by a bypass conduit 44 coupled to the bypass passage outlet 34. The first valve 60 is located within the main exhaust passage 28 and is configured to move to any desired position between a fully open position 64 (in phantom) and a fully closed position 66 (in solid). The second valve 62 is located within the bypass passage 22 and is configured to move to any desired position between a fully open position 68 (in solid) and a fully closed position 70 (in phantom). Although illustrated in the example implementation as butterfly valves, it will be appreciated that valves 60, 62 may be any suitable valve that enables light-off catalyst bypass system 14 to operate as described herein.

A controller 72 (e.g., engine control unit) is in signal communication with the first valve 60 and the second valve 62 and is configured to move the first and second valves 60, 62 to any position between their respective fully open and fully closed positions. As used herein, the term controller refers to an application specific integrated circuit (ASIC), an electronic circuit, a processor (shared, dedicated, or group) and memory that executes one or more software or firmware programs, a combinational logic circuit, and/or other suitable components that provide the described functionality.

In one example, the bypass catalyst 38 is a three-way catalyst configured to remove CO, HC, and NOx from the exhaust gas passing therethrough, as described herein in more detail. However, it will be appreciated that bypass catalyst 38 may be any suitable catalyst that enables light-off catalyst bypass system 14 to remove any desired pollutant or compound such as, for example, a hydrocarbon trap or a four-way catalyst. In another example, bypass catalyst 38 has a cell density of between approximately 800 and approximately 1200 cells per square inch, or between 800 and 1200 cells per square inch.

In the example embodiment, cylinder head 10 also includes a water jacket 24. Advantageously, the water jacket 24 includes flow channels 74 extended to and disposed about the bypass passage 22 and the bypass catalyst 38. In this way, the cylinder head coolant loop extends around the bypass catalyst 38 and is configured to supply coolant (e.g., water) around the bypass catalyst 38. By keeping the bypass catalyst 38 at a lower temperature, particularly when exhaust gas is not passing therethrough (e.g., during normal operation), the life and durability of the catalyst 38 is extended.

In the example embodiment, the light-off catalyst bypass system 14 is configured to selectively operate in (i) a normal or warm catalyst mode, (ii) a cold catalyst mode, and (iii) a mixed flow mode. In the warm catalyst mode, controller 72 determines the main catalytic converter 52 has reached the predetermined light-off temperature (e.g., via temperature sensor, modeled, etc.) and moves the first valve 60 to the fully open position 64 and the second valve 62 to the fully closed position 70. In this mode, the fully closed second valve 62 facilitates preventing the exhaust gas in the integrated exhaust manifold 20 from entering the bypass passage 22 and thus bypass catalyst 38. Instead, the exhaust gas is directed through main exhaust passage 28, into the main exhaust conduit 50, and through the main catalytic converter 52 before being exhausted to the atmosphere.

In the cold catalyst mode, controller 72 determines the main catalytic converter 52 is below the predetermined light-off temperature or that another vehicle condition exists such as, for example, a cold start or long idle condition. The controller 72 moves the first valve 60 to the fully closed position 66 and the second valve 62 to the fully open position 68. In this mode, the fully closed first valve 60 facilitates preventing the exhaust gas in the integrated exhaust manifold 20 from entering the main exhaust conduit 50. Instead, the exhaust gas is directed through bypass passage 22 and bypass catalyst 38 before being directed to the main exhaust conduit 50 and atmosphere. Once the main catalytic converter 52 has reached the light-off temperature, the controller 72 may then switch the light-off catalyst bypass system 14 to the normal mode.

In the mixed flow mode, controller 72 moves the first valve 60 to a partially open/closed condition and moves the second valve 62 to a partially open/closed position. In this mode, depending on the opening amount of the first and second valves 60, 62, a first portion of the exhaust gas in the integrated exhaust manifold 20 is directed through the main exhaust passage 28 and into the main exhaust conduit 50. At the same time, a second portion of the exhaust gas in the integrated exhaust manifold 20 is directed through bypass passage 22 and bypass catalyst 38. The two portions of exhaust gas recombine in the main exhaust conduit 50 and are subsequently passed through the main catalytic converter 52 and exhausted to atmosphere. It will be appreciated that controller 72 can make real time adjustments to the opening percentage of each of the first and second valves 60, 62 to control various conditions of the vehicle and its exhaust system.

Accordingly, cylinder head 10 provides a liquid cooled, integrated auxiliary catalyst 38 that can allow exhaust gas to bypass the main exhaust path, for example, during cold start, long ide, and low main catalyst 52 temperature conditions. The cylinder head 10 also includes an integrated valve system with valves 60, 62, which are also liquid cooled by water jacket 24. In this way, cylinder head 10 enables increased emissions system efficacy with decreased degradation due to aging.

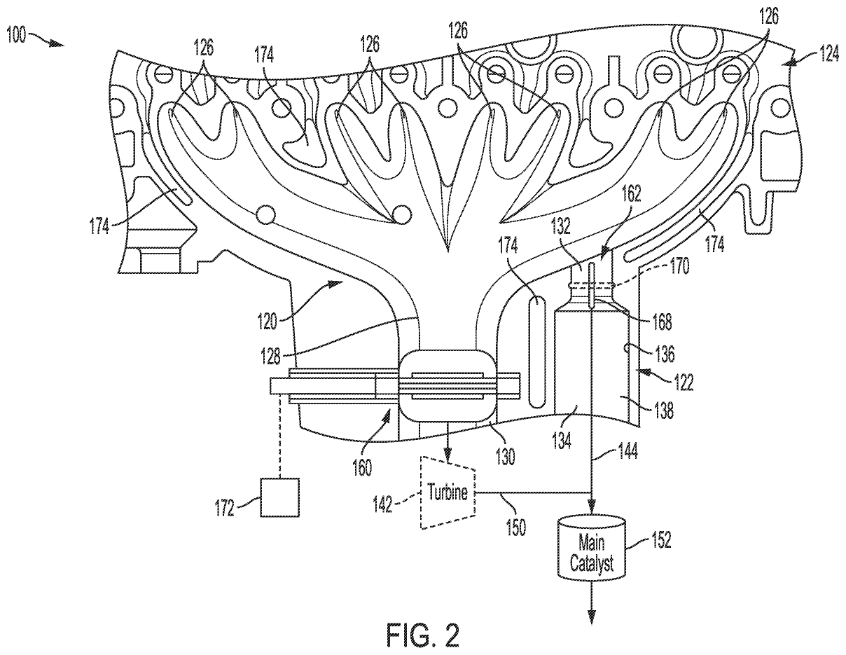

FIG. 2 illustrates an alternative embodiment of the cylinder head at 100. Cylinder head 100 is similar to cylinder head 10 except a bypass passage 122 includes an inlet 132 located on a cylinder exhaust passage 126, as well as arranges the bypass catalyst 138 substantially perpendicular to a main exhaust passage 128, as opposed to substantially perpendicular in cylinder head 10. Additionally, a first valve 160 is disposed with a rotational axis horizontally across the main exhaust passage 128 rather than disposed vertically as in cylinder head 10.

In the example embodiment, the cylinder head 100 generally defines an integrated exhaust manifold 120, bypass passage 122, and a water jacket 124. The integrated exhaust manifold 120 includes a plurality of cylinder exhaust passages 126 that merge together to form main exhaust passage 128 having an outlet 130. The bypass passage 122 includes inlet 132, an outlet 134 and defines a catalyst cavity 136, which is configured to removably receive a bypass catalyst 138, which is described herein in more detail.

In the example embodiment, a main exhaust aftertreatment system 112 generally includes a main exhaust conduit 150 having one or more main catalytic converters 152 to reduce or convert a desired exhaust gas constituent such as, for example, carbon monoxide (CO), hydrocarbon (HC), and/or nitrogen oxides (NOx). The main exhaust conduit 150 is fluidly coupled to the integrated exhaust manifold main outlet 130 (optionally via a turbocharger turbine 142, shown in phantom) and configured to receive exhaust gas from the vehicle engine and supply the exhaust gas to the main catalytic converter 152. In order to efficiently reduce or convert CO, HC, and NOx, the catalytic converter 152 must reach a predetermined light-off temperature. However, during some vehicle operations such as, for example, cold starts, long idle, and cold catalyst conditions, the catalytic converter 152 is below light-off temperature and therefore has a low catalyst conversion efficiency.

In order efficiently reduce or convert the unwanted exhaust gas constituents while the catalytic converter 152 is below the light-off temperature, the vehicle utilizes a light-off catalyst bypass system 114 to redirect at least a portion of the exhaust gas from the integrated exhaust manifold 120, into the bypass passage 122, and through the bypass catalyst 138. Because the bypass catalyst 138 is integrated into the cylinder head 100, it is in close proximity to the engine combustion chambers and receives the exhaust gas quicker and at a higher temperature than the main catalytic converter 152 would. Thus, the bypass catalyst 138 is rapidly heated to its predetermined light-off temperature to achieve high catalyst conversion efficiency before the main catalytic converter 152 alone.

In the example embodiment, the light-off catalyst bypass system 114 generally includes the bypass catalyst 138, first valve 160, and a second valve 162. The bypass catalyst 138 is disposed within the bypass passage 122, which is fluidly connected to the main exhaust conduit 150 upstream of the main catalytic converter 152 by a bypass conduit 144 coupled to the bypass passage outlet 134. The first valve 160 is located within the main exhaust passage 128 and is configured to move to any desired position between a fully open position 164 (not shown) and a fully closed position 166. The second valve 162 is located within the bypass passage 122 and is configured to move to any desired position between a fully open position 168 (in solid) and a fully closed position 170 (in phantom). Although illustrated in the example implementation as butterfly valves, it will be appreciated that valves 160, 162 may be any suitable valve that enables light-off catalyst bypass system 114 to operate as described herein.

A controller 172 (e.g., engine control unit) is in signal communication with the first valve 160 and the second valve 162 and is configured to move the first and second valves 160, 162 to any position between their respective fully open and fully closed positions.

In one example, the bypass catalyst 138 is a three-way catalyst configured to remove CO, HC, and NOx from the exhaust gas passing therethrough, as described herein in more detail. However, it will be appreciated that bypass catalyst 138 may be any suitable catalyst. In another example, bypass catalyst 138 has a cell density of between approximately 800 and approximately 1200 cells per square inch, or between 800 and 1200 cells per square inch.

In the example embodiment, cylinder head 100 also includes a water jacket 124. Advantageously, the water jacket 124 includes flow channels 174 extended to and disposed about the bypass passage 122 and the bypass catalyst 138. In this way, the cylinder head coolant loop extends around the bypass catalyst 138 and is configured to supply coolant around the bypass catalyst 138. By keeping the bypass catalyst 138 at a lower temperature, particularly when exhaust gas is not passing therethrough, the life and durability of the catalyst 138 is extended.

Described herein are systems and methods for improving vehicle emissions systems efficiency, particularly during cold start, long idle, and low main catalyst temperature conditions. The system includes a small bypass catalyst system located very close to the exhaust port(s) inside the cylinder head. The small catalyst system can receive exhaust flow during light-of (start-up), extended idle, some low load conditions, or other conditions. The small catalyst utilizes the relatively low temperature of the water jacketed cylinder head for cooling to minimize aging, and the system includes at least one valve located between the exhaust ports and the turbocharger or exhaust manifold. The valve selectively blocks flow to the small catalyst, for example, depending on pressure differentials forced by the specific design the system is being adapted for.

When the valve is in a light-off position, exhaust gases from the exhaust ports are directed through the small bypass catalyst. When the valve is in normal operating condition, the exhaust flow is directed through the manifold and optional turbocharger. The valve actuator can have continuous control over the flow split between the light-off and normal valve positions, for example, to allow for increased water cooling of the assembly to prolong life of the small bypass catalyst.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. A cylinder head assembly for an internal combustion engine, the assembly comprising:
a cylinder head;
a bypass passage formed within the cylinder head and defining a catalyst cavity; and
a bypass catalytic converter disposed within the catalyst cavity, the bypass catalytic converter configured to provide emissions reduction during cold start, long idle, and/or low main catalytic converter temperature conditions.

2. The assembly of claim 1, wherein the bypass passage is integrally cast within the cylinder head.

3. The assembly of claim 1, further comprising an integrated exhaust manifold formed in the cylinder head and including a main exhaust passage and an outlet, the integrated exhaust manifold configured to receive exhaust gas from exhaust ports of the internal combustion engine.

4. The assembly of claim 3, wherein the bypass passage includes an inlet and an outlet, the bypass passage inlet fluidly coupled to the main exhaust passage.

5. The assembly of claim 1, further comprising a valve disposed within the bypass passage and configured to selectively allow exhaust gas flow through the bypass passage and thus the bypass catalytic converter.

6. The assembly of claim 3, further comprising a valve disposed within the main exhaust passage and configured to selectively allow exhaust gas flow through the main exhaust passage outlet to the main catalytic converter.

7. The assembly of claim 6, further comprising a second valve disposed within the bypass passage and configured to selectively allow exhaust gas flow through the bypass passage and thus the bypass catalytic converter.

8. The assembly of claim 1, further comprising a water jacket formed in the cylinder head proximate the catalyst cavity and configured to circulate a coolant to provide cooling to the bypass catalytic converter.

9. The assembly of claim 1, further comprising a service port formed in the cylinder head and configured to removably receive a cap, wherein the cap is removable to enable insertion or removal of the bypass catalytic converter through the service port.

10. An internal combustion engine system comprising:
a cylinder head;
an integrated exhaust manifold formed in the cylinder head and including a main exhaust passage having an outlet;
a bypass passage formed within the cylinder head and defining a catalyst cavity;
an exhaust aftertreatment system having a main exhaust conduit with a main catalytic converter, wherein the main exhaust conduit is fluidly coupled to both the main exhaust passage outlet and the bypass passage; and
a bypass catalytic converter disposed within the catalyst cavity, the bypass catalytic converter configured to provide emissions reduction during cold start, long idle, and/or low main catalytic converter temperature conditions.

11. The system of claim 10, further comprising a water jacket formed in the cylinder head proximate the catalyst cavity and configured to circulate a coolant to provide cooling to the bypass catalytic converter.

12. The system of claim 10, wherein the bypass passage is fluidly coupled to the main exhaust conduit at a location upstream of the main catalytic converter.

13. The system of claim 10, further comprising a valve disposed within the bypass passage and configured to selectively allow exhaust gas flow through the bypass passage and thus the bypass catalytic converter.

14. The system of claim 10, further comprising a valve disposed within the main exhaust passage and configured to selectively allow exhaust gas flow through the main exhaust passage outlet to the main catalytic converter.

15. The system of claim 14, further comprising a second valve disposed within the bypass passage and configured to selectively allow exhaust gas flow through the bypass passage and thus the bypass catalytic converter.

16. The system of claim 10, further comprising a service port formed in the cylinder head and configured to removably receive a cap, wherein the cap is removable to enable insertion or removal of the bypass catalytic converter through the service port.
